(19) United States
(12) Patent Application Publication
(10) Pub. No.: US 2024/0224387 A1
(43) Pub. Date: Jul. 4, 2024

(54) MICROWAVE HEATING DEVICE

(71) Applicant: Industrial Technology Research Institute, Hsinchu (TW)

(72) Inventors: Kun-Ping Huang, Miaoli County (TW); Jwu-Sheng Hu, Hsinchu County (TW); Yueh-Lin Tsai, Yunlin County (TW)

(73) Assignee: Industrial Technology Research Institute, Hsinchu (TW)

(21) Appl. No.: 18/177,124

(22) Filed: Mar. 2, 2023

(30) Foreign Application Priority Data
Jan. 3, 2023 (TW) 112100047

(51) Int. Cl. H05B 6/70; H05B 6/64

(52) U.S. Cl. CPC H05B 6/707; H05B 6/6411

(57) ABSTRACT

A microwave heating device including a chamber and a plurality of microwave sources is provided. The chamber is configured to accommodate at least one target. The plurality of microwave sources are disposed at a top of the chamber to emit a microwave to the target. An included angle between a direction of microwave electric field of a portion in the plurality of microwave sources and a direction of microwave electric field of another portion in the plurality of microwave sources is between 80 degrees and 100 degrees.

### CROSS-REFERENCE TO RELATED APPLICATION

This application claims the priority benefit of Taiwan application serial no. 112100047, filed on Jan. 3, 2023. The entirety of the above-mentioned patent application is hereby incorporated by reference herein and made a part of this specification.

### TECHNICAL FIELD

The disclosure relates to a microwave device, and more particularly to a microwave heating device.

### BACKGROUND

In the semiconductor manufacturing process, thermal annealing modification is needed for process steps such as dopant activation, defect repair, or polymer curing. In order to avoid dopant diffusion or damage to the material structure, the allowable value of annealing temperature is constantly reduced. Microwave annealing may meet the object of low-temperature annealing, and also may anneal a plurality of wafers at the same time, and is gradually widely adopted in semiconductor manufacturing processes. However, common microwave devices configured for annealing treatment have issues such as large volume and long anneal time.

### SUMMARY

The disclosure provides a microwave heating device.

A microwave heating device of an embodiment of the disclosure includes a chamber and a plurality of microwave sources. The chamber is configured to accommodate at least one target. The plurality of microwave sources are disposed at a top of the chamber to emit a microwave to the target. An included angle between a direction of microwave electric field of a portion in the plurality of microwave sources and a direction of microwave electric field of another portion in the plurality of microwave sources is between 80 degrees and 100 degrees.

Several exemplary embodiments accompanied with figures are described in detail below to further describe the disclosure in details.

### BRIEF DESCRIPTION OF THE DRAWINGS

FIG. 1A is a schematic diagram of a microwave heating device of an embodiment of the disclosure.

FIG. 1B is a schematic cross-sectional view of the microwave heating device of FIG. 1A.

FIG. 1C is a schematic top view of the microwave heating device of FIG. 1A.

FIG. 2A and FIG. 2B are schematic partial top views of microwave heating devices of other embodiments of the disclosure.

FIG. 3 is a schematic diagram of a microwave heating device of another embodiment of the disclosure.

FIG. 4 is a schematic diagram of a microwave heating device of another embodiment of the disclosure.

### DETAILED DESCRIPTION OF DISCLOSED EMBODIMENTS

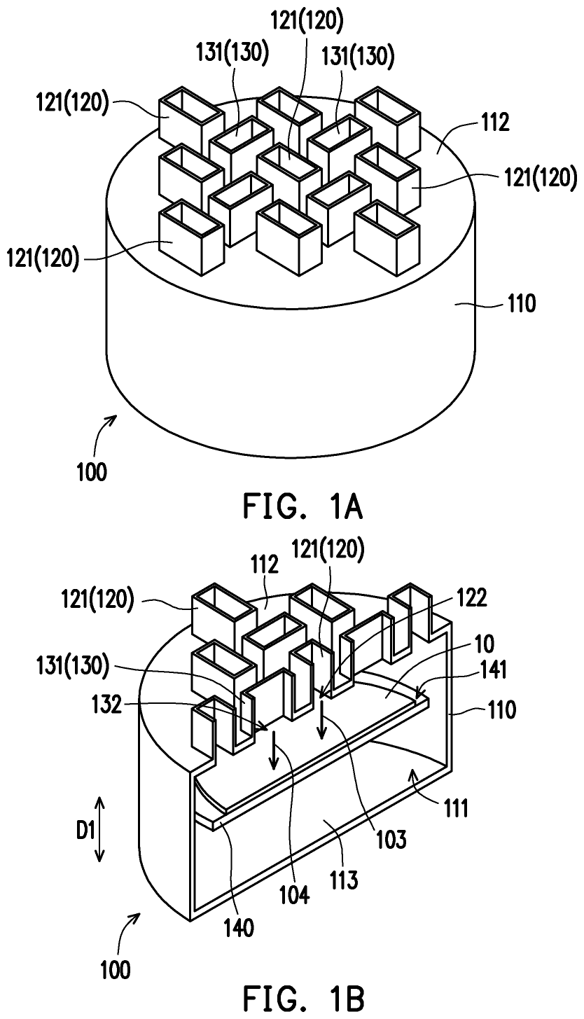

FIG. 1A is a schematic diagram of a microwave heating device of an embodiment of the disclosure. FIG. 1B is a schematic cross-sectional view of the microwave heating device of FIG. 1A. FIG. 1C is a schematic top view of the microwave heating device of FIG. 1A. Please refer to FIG. 1A and FIG. 1B, a microwave heating device 100 may be applied in a semiconductor manufacturing process, for example, in the annealing treatment of a wafer 10. Specifically, the microwave heating device 100 includes a chamber 110, a plurality of first microwave sources 120, and a plurality of second microwave sources 130, wherein a heating space 111 of the chamber 110 may be configured to accommodate at least one target (such as the wafer 10), and the plurality of first microwave sources 120 and the plurality of second microwave sources 130 are disposed at a top 112 of the chamber 110 to input microwave into the heating space 111 from above the wafer 10. For example, the plurality of first microwave sources 120 and the plurality of second microwave sources 130 may be a plurality of fixed-frequency microwave sources or a plurality of variable-frequency microwave sources.

The plurality of first microwave sources 120 and the plurality of second microwave sources 130 input microwaves into the heating space 111 from above the wafer 10 to emit microwaves to the front of the wafer 10, so that the heating effect of the plurality of first microwave sources 120 and the plurality of second microwave sources 130 on the wafer 10 is significantly improved.

Please refer to FIG. 1B, the microwave heating device 100 further includes a carrier 140 disposed in the chamber 110. Specifically, the carrier 140 is located in the heating space 111 of the chamber 110, wherein the carrier 140 is configured to carry the wafer 10, and may be rotated and/or lifted in the heating space 111. The carrier 140 has a carrying surface 141 configured to carry the wafer 10, and in a direction D1 perpendicular to the carrying surface 141, the projection (for example, orthographic projection) of at least a portion in the plurality of first microwave sources 120 and at least a portion in the plurality of second microwave sources 130 falls on the carrying surface 141.

Please refer to FIG. 1B and FIG. 1C, the included angle between a direction 101 of microwave electric field of the plurality of first microwave sources 120 and a direction 102 of microwave electric field of the plurality of second microwave sources 130 is 90 degrees. In other words, the direction 101 of microwave electric field of the plurality of first microwave sources 120 is orthogonal to or perpendicular to the direction 102 of microwave electric field of the plurality of second microwave sources 130. More specifically, the direction 101 of microwave electric field of the plurality of first microwave sources 120 and the direction 102 of microwave electric field of the plurality of second microwave sources 130 are parallel to the carrying surface 141 of the carrier 140, and a direction 103 of microwave propagation of the plurality of first microwave sources 120 and a direction 104 of microwave propagation of the plurality of second microwave sources 130 are perpendicular to the carrying surface 141 of the carrier 140, so as to emit microwaves to the front of the wafer 10 to improve heating effect.

In the present embodiment, the plurality of first microwave sources 120 and the plurality of second microwave sources 130 may emit microwaves sequentially or randomly, and within a time interval, at least two first microwave sources 120, at least two second microwave sources 130, or at least one first microwave source 120 and at least one second microwave source 130 successively emit microwaves, and the waveform bandwidths are overlapped and coupled to generate coupling modes. In other words, although each of the microwave sources may emit independently, the microwaves successively emitted by at least two microwave sources may interfere with each other to generate coupling modes, increase the number of microwave modes, and achieve the object of uniform heating of multiple modes.

Referring to FIG. 1A and FIG. 1B, each of the first microwave sources 120 may include a first waveguide tube 121, and the connection between the first waveguide tube 121 and the heating space 111 of the chamber 110 defines a first microwave input port 122. Moreover, each of the second microwave sources 130 may include a second waveguide tube 131, and the connection between the second waveguide tube 131 and the heating space 111 of the chamber 110 defines a second microwave input port 132.

As shown in FIG. 1A, the plurality of first waveguide tubes 121 and the plurality of second waveguide tubes 131 may be a plurality of rectangular waveguide tubes, and the plurality of first waveguide tubes 121 are perpendicular to the plurality of second waveguide tubes 131. In other words, the plurality of first waveguide tubes 121 and the plurality of second waveguide tubes 131 are arranged orthogonally. For example, a portion of the plurality of first waveguide tubes 121 is disposed in the periphery of the plurality of second waveguide tubes 131 to surround the plurality of second waveguide tubes 131. Moreover, the plurality of second waveguide tubes 131 surround one first waveguide tube 121 substantially in the middle of the top 112 of the chamber 110 to separate the first waveguide tube 121 from the other plurality of first waveguide tubes 121.

As shown in FIG. 1B, the plurality of first microwave input ports 122 of the plurality of first microwave sources 120 are perpendicular to the plurality of second microwave input ports 132 of the plurality of second microwave sources 130. In other words, the plurality of first microwave input ports 122 and the plurality of second microwave input ports 132 are arranged orthogonally.

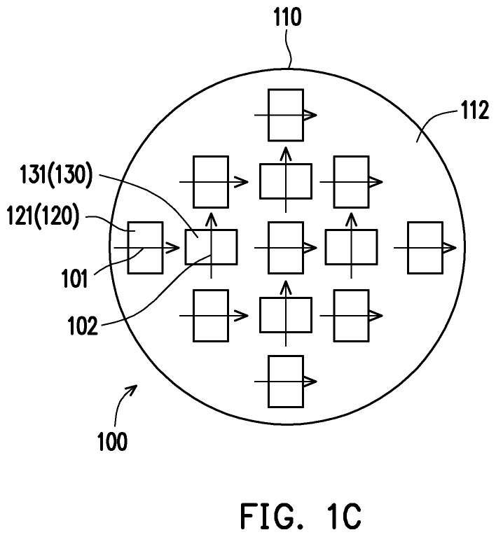

FIG. 2A and FIG. 2B are schematic partial top views of microwave heating devices of other embodiments of the disclosure. As shown in FIG. 2A, the direction 101 of microwave electric field of the first microwave source 120 may be not perpendicular to the direction 102 of microwave electric field of the second microwave source 130, and the included angle between the direction 101 of microwave electric field and the direction 102 of microwave electric field may be greater than 90 degrees and less than or equal to 100 degrees. As shown in FIG. 2B, the direction 101 of microwave electric field of the first microwave source 120 may be not perpendicular to the direction 102 of microwave electric field of the second microwave source 130, and the included angle between the direction 101 of microwave electric field and the direction 102 of microwave electric field may be less than 90 degrees and greater than or equal to 80 degrees.

For example, the included angle between the direction of microwave electric field of a portion in the plurality of microwave sources and the direction of microwave electric field of another portion in the plurality of microwave sources may be between 80 degrees and 100 degrees, preferably between 85 degrees and 95 degrees, such as equal to 90 degrees.

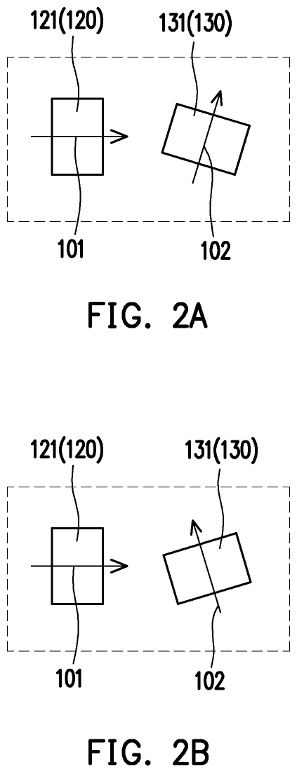

FIG. 3 is a schematic diagram of a microwave heating device of another embodiment of the disclosure. In order to clearly show the internal structural configuration of the chamber 110, the chamber 110 in FIG. 3 is presented in perspective drawing. Referring to FIG. 3, a microwave heating device 100A is substantially the same as the microwave heating device 100 of the previous embodiment, and the difference is: the microwave heating device 100A adopts a plurality of supports 150 disposed in the chamber 110 to support and carry at least one target (such as the wafer 10). Specifically, the plurality of supports 150 are located in the heating space 111 of the chamber 110 and extended from a bottom 113 to the top 112 of the chamber 110. The plurality of supports 150 are parallel to each other, and an extending direction D2 of the plurality of supports 150 is perpendicular to the direction 101 of microwave electric field of the plurality of first microwave sources 120 and the direction 102 of microwave electric field of the plurality of second microwave sources 130. Moreover, the extending direction D2 of the plurality of supports 150 is parallel to the direction 103 of microwave propagation of the plurality of first microwave sources 120 and the direction 104 of microwave propagation of the plurality of second microwave sources 130.

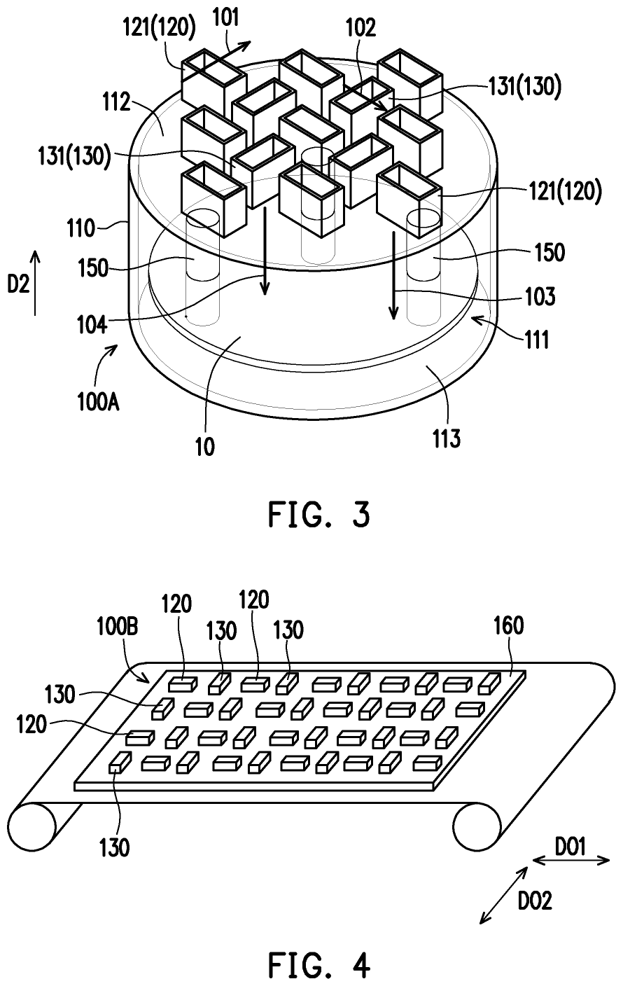

FIG. 4 is a schematic diagram of a microwave heating device of another embodiment of the disclosure. Referring to FIG. 4, the plurality of first microwave sources 120 and the plurality of second microwave sources 130 in a microwave heating device 100B are disposed on a carrier 160, and in a first direction D01 and a second direction D02 perpendicular to the first direction D01, the plurality of first microwave sources 120 and the plurality of second microwave sources 130 are arranged alternately, and any first microwave source 120 is arranged vertically or orthogonally to any second microwave source 130. In an example, the microwave heating device 100B may be configured for food processing, and the food may be conveyed via a conveying equipment under the microwave heating device 100B, so as to heat or bake the food via the microwave heating device 100B. In another example, the microwave heating device 100B may be configured for roll-to-roll processing to heat a flexible film or inks, gels, other materials, or other elements on the flexible film conveyed underneath, wherein the flexible film may be a plastic film, flexible glass, or a film made of other flexible materials.

Based on the above, in the microwave heating device of the disclosure, the microwave source is disposed at the top of the chamber (i.e., above the target), thus helping to improve the heating effect of the microwave source on the target.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A microwave heating device, comprising:
a chamber configured to accommodate at least one target; and
a plurality of microwave sources disposed at a top of the chamber to emit a microwave to the at least one target, wherein an included angle between a direction of microwave electric field of a portion in the plurality of microwave sources and a direction of microwave electric field of another portion in the plurality of microwave sources is between 80 degrees and 100 degrees.

2. The microwave heating device of claim 1, wherein an included angle between a direction of microwave electric field of a portion in the plurality of microwave sources and a direction of microwave electric field of another portion in the plurality of microwave sources is between 85 degrees and 95 degrees.

3. The microwave heating device of claim 1, wherein an included angle between a direction of microwave electric field of a portion in the plurality of microwave sources and a direction of microwave electric field of another portion in the plurality of microwave sources is 90 degrees.

4. The microwave heating device of claim 1, further comprising:
a carrier rotatably and liftably disposed in the chamber and having a carrying surface configured to carry the at least one target.

5. The microwave heating device of claim 4, wherein a direction of microwave electric field of the plurality of microwave sources is parallel to the carrying surface, and a direction of microwave propagation of the plurality of microwave sources is perpendicular to the carrying surface.

6. The microwave heating device of claim 4, wherein in a direction perpendicular to the carrying surface, a projection of at least a portion in the plurality of microwave sources falls on the carrying surface.

7. The microwave heating device of claim 1, further comprising:
a plurality of supports disposed in the chamber and extended from a bottom of the chamber to the top and configured to carry the at least one target.

8. The microwave heating device of claim 7, wherein an extending direction of the plurality of supports is perpendicular to a direction of microwave electric field of the plurality of microwave sources, and the extending direction of the plurality of supports is parallel to a direction of microwave propagation of the plurality of microwave sources.

9. The microwave heating device of claim 1, wherein the plurality of microwave sources emit a microwave sequentially or randomly, and within a time interval, at least two of the microwave sources emit microwaves coupled to each other.

10. The microwave heating device of claim 1, wherein the plurality of microwave sources have a plurality of first microwave input ports and a plurality of second microwave input ports, and the plurality of first microwave input ports are perpendicular to the plurality of second microwave input ports.

11. The microwave heating device of claim 1, wherein the plurality of microwave sources comprise a plurality of first waveguide tubes and a plurality of second waveguide tubes, and a portion in the plurality of first waveguide tubes surrounds the plurality of second waveguide tubes.

12. The microwave heating device of claim 1, wherein the plurality of microwave sources comprise a plurality of first waveguide tubes and a plurality of second waveguide tubes, and the plurality of second waveguide tubes surround one of the plurality of first waveguide tubes.

13. The microwave heating device of claim 1, wherein the plurality of microwave sources comprise a plurality of fixed-frequency microwave sources or a plurality of variable-frequency microwave sources.
